(19) United States
(12) Patent Application Publication
(10) Pub. No.: US 2009/0321189 A1
(43) Pub. Date: Dec. 31, 2009

(54) LIFTING DEVICE, PARTICULARLY FOR MOTOR VEHICLES

(75) Inventor: Winfried Schmitt, Bichl (DE)

Correspondence Address: OLIFF & BERRIDGE, PLC, P.O. BOX 320850, ALEXANDRIA, VA, 22320-4850, US

(73) Assignee: Maha Maschinenbau Haldenwang GmbH & Co. KG, Haldenwang (DE)

(21) Appl. No.: 12/309,858

(22) PCT Filed: Jul. 18, 2007
(86) PCT No.: PCT/EP2007/006381

§ 371 Date: Feb. 2, 2009

(30) Foreign Application Priority Data
Aug. 23, 2006 (DE) 10 2006 039 472.0

(51) Int. Cl. B66F 7/28; B66F 7/16

(52) U.S. Cl. 187/215; 187/216

(57) ABSTRACT

The object of the invention is a lifting device, particularly for motor vehicles, having a lifting unit and load-bearing functional elements, such as travel rails, stators, support arms, or the like. These load-bearing functional elements are made of extruded light metal hollow profiles having integrally formed reinforcements, whereby less expensive production as opposed to a conventional steel construction is achieved.

The invention relates to a lifting device, particularly for motor vehicles, having at least a lifting unit and load-bearing functional elements, such as travel rails, support arms, stators, or the like.

Lifting devices for motor vehicles are known in different types and designs, for example, as column lifting platforms, as lifting plunger platforms, or as pantograph lifting platforms. All of these lifting platforms have at least a lifting unit provided with an electric, hydraulic or pneumatic drive, which lifts and lowers the load-bearing functional elements of the lifting platform in a controlled manner mostly with the vehicle supported thereon. The load-bearing functional elements include, for example, the horizontal running rails on which the vehicle is supported with its wheels, the swiveling telescopic support arms positioned below predetermined sites of the vehicle floor with their end-side support blocks, and also the spreader beams of pantograph lifting platforms, which are connected to each other in an articulated manner. Depending on the application, these functional elements formed as extended beams have different cross-sectional profiles. In order to be able to receive the up-coming loads safely and without deformation, the load-bearing functional elements consist of shaped steel structures. To manufacture them, plate-shaped blanks of rolled flat material are formed, for example, into hollow profile beams by longitudinal bending, which requires the use of complex machinery. As diagonal members and bolts are incorporated at regular intervals in order to reinforce the beams, the efforts of manufacture increase due to the finishing and welding-in of these reinforcement elements.

It is the object of the invention to facilitate the development, manufacture and assembly of the load-bearing functional elements of motor vehicle lifting platforms and to reduce the production costs of the respective lifting platform.

According to the invention, this object is achieved by the fact that the load-bearing functional elements of the motor vehicle lifting platform consist of extruded light metal profiles, in particular hollow profiles made of aluminium and its alloys, comprising integrally formed reinforcements.

The dimensioning and profile design of the inventive extruded hollow profiles is met such that the loads occurring during operation, when the motor vehicles supported thereon are lifted and lowered, can be received without bending deformations, even in consideration of the required safety factors. An essential advantage of the invention is the fact that the light metal hollow profiles according to the invention are acquired as prefabricated semi-finished products. The forming processes required for the previous steel structures and also the machinery needed therefor are no longer necessary. The results thereof are substantially lower manufacturing costs and simplified operating procedures. The strength and flexural rigidity required for the respective different functional elements is guaranteed by selecting suitable profile cross-sections and sufficient wall thicknesses. Particularly, this applies to the hollow profiles used as travel rails, which have a flat-rectangular cross-section with longitudinal cavities defined by fixed links. Providing these channel-like longitudinal cavities increases the flexural rigidity of the one-piece travel rail the upper contact surface of which should be roughened or provided with a non-slip lining. Apart from that, the longitudinal cavities of the hollow profiles may also serve to receive additional structural members. Suitably, each hollow profile has two laterally closed longitudinal cavities below the travel surface.

In underground lifting plunger platforms the travel rails are fastened with their plate-shaped middle part between the two longitudinal cavities on the upper end plates of underground lifting plungers and their guide pipes, respectively.

In four-column lifting platforms the travel rails are fastened with their end parts to transverse beams formed as light metal hollow profiles and guided at the end-side on the columns by a motor in a movable fashion. Preferably, the transverse beams can be moved vertically on the columns by means of traction cords which are coupled via pulleys to a head of a piston rod of a pressurizing medium cylinder. In this case, it is suitable to arrange the pressurizing medium cylinder with its piston rod and the piston rod head inside a hollow profile of a guide rail.

In pantograph lifting platforms, not only the travel rails but also the pantograph beams may be formed as light metal profiles.

Further advantages and particular features of the invention can be taken from the following description of embodiments shown in the drawings, wherein:

FIG. 1 shows a schematic perspective illustration of a four-column lifting platform for motor vehicles;

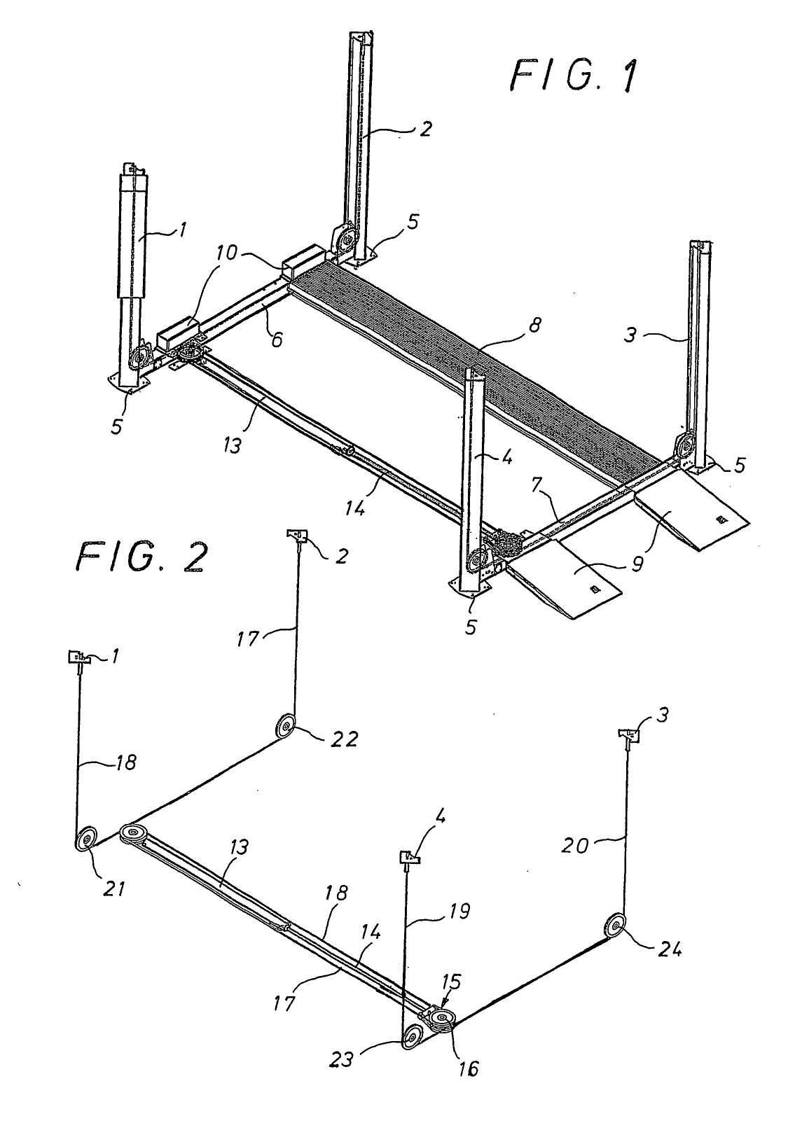

FIG. 2 schematically shows the drive elements of the lifting platform according to FIG. 1;

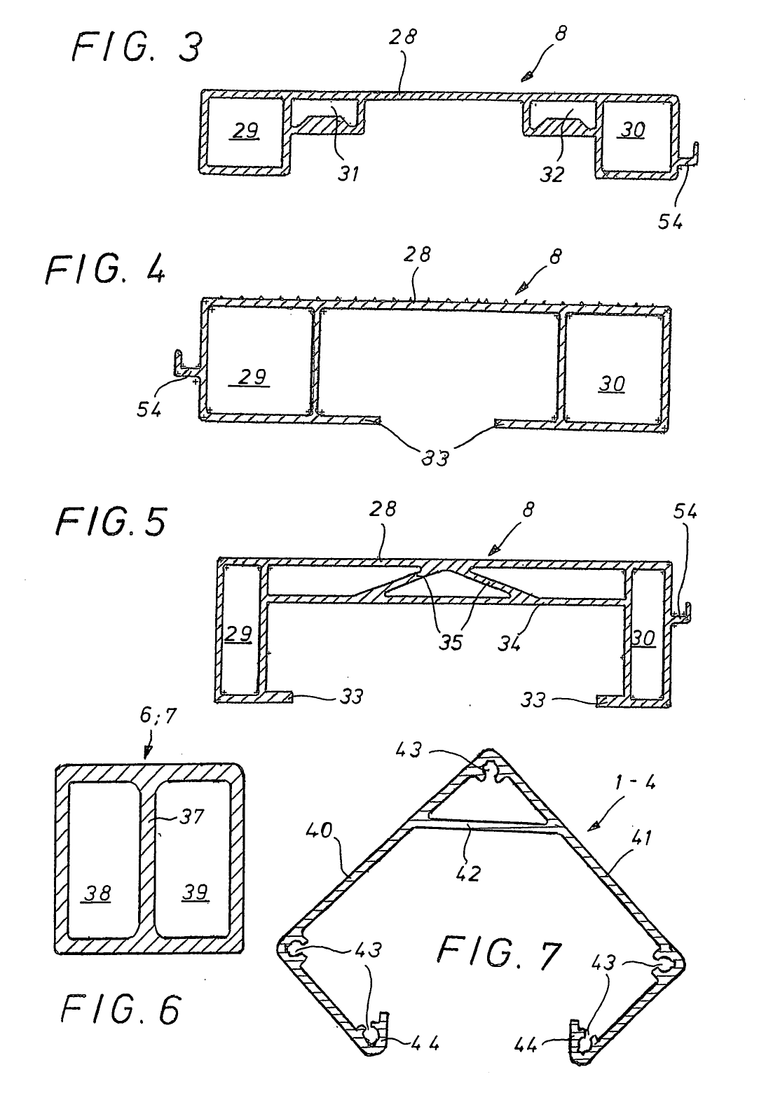

FIG. 3 to

FIG. 7 show cross-sections of various light metal hollow profiles used as functional elements of lifting platforms;

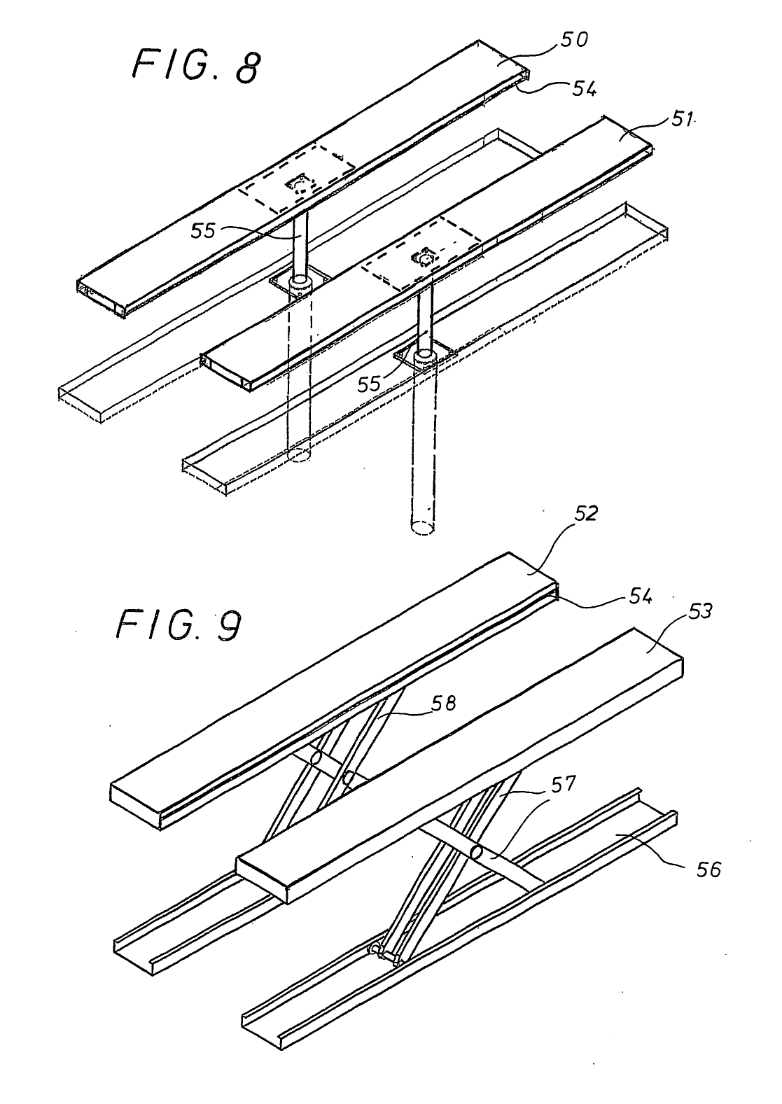

FIG. 8 shows a schematic perspective illustration of a two-plunger lifting platform;

FIG. 9 shows a schematic perspective illustration of a pantograph lifting platform.

The motor vehicle lifting platform shown in FIGS. 1 and 2 comprises four columns 1 to 4 mounted to the basis of a shop floor via a respective stand 5. In the embodiment as shown, the columns consist of light metal hollow profiles one embodiment of which is shown in FIG. 7. Between two respective columns 1, 2 and 3, 4, a respective transverse beam 6, 7 is disposed, and these transverse beams may be formed as light metal hollow profiles in the embodiment as shown in FIG. 6 in cross-section. Two running rails 8, of which only one is shown in FIG. 1, are fastened to the two transverse beams 6, 7. These running or travel rails have a roughened plane surface or are provided with a friction lining. In an extension of the running rails ramps 9 are arranged, preferably attached in an articulated manner, to the front transverse beam 7 in FIG. 1. At the rear end of each travel rail 8, limit blocks 10 are fastened to the rear transverse beam 6, which prevent a vehicle from rolling out accidentally.

The drive system of the column lifting platform illustrated in FIG. 1 comprises a pressurizing medium cylinder 13 which is arranged inside the travel rail 8 formed as a light metal hollow profile and the piston rod 14 of which supports a piston rod head 15 having pulleys 16. In total, four ropes 17, 18, 19, 20 engage with this piston rod head 15, the ends of which are attached to the upper end parts of the four columns 1 to 4. Each rope 17 to 20 runs over a respective deflection pulley 21 to 24 supported in corresponding seats at the end of the transverse beams 6, 7. By extending or retracting the piston rod 14 in the cylinder 13, the piston rod head 15 is shifted inside the travel rail hollow profile, whereby the transverse bars 6, 7 and, together with the same, the travel rails 8 as well are lifted or lowered via corresponding rope movements.

FIGS. 3 to 5 illustrate light metal profile rails in cross-section which may be used as travel rails 8 in the column lifting platform according to FIG. 1. These travel rails are one-piece extruded light metal hollow profiles having an upper continuous travel surface 28 and two lateral longitudinal cavities 29, 30 of respectively rectangular cross-section. In the embodiment according to FIG. 3 two channel-like molds 31, 32, which represent a reinforcement member together with a thickened lower wall for the rail 8, are positioned on the inner surface of the two longitudinal cavities 29, 30. The limiting walls of the lateral cavities 29, 30 have a similar function, as do the lower struts 33 on both sides in the embodiment according to FIGS. 4 and 5. In the embodiment according to FIG. 5, an inner continuous wall element 34 comprising two diagonal struts 35 is provided for reinforcement.

The transverse beam 6, 7 illustrated in FIG. 6 is also a light metal hollow profile of substantially square cross-section, the interior of which is divided by a middle wall 37 into two longitudinally continuous chambers 38, 39. The middle wall 37 is used to increase the rigidity of the transverse beam 6, 7.

FIG. 7 illustrates a cross-section of one of the stators 1 to 4. The stators also consist of a respective one-piece extruded light metal hollow profile which in the embodiment according to FIG. 7 has an approximately square cross-section. Two continuous side walls 40, 41 are connected to each other by a fixed link 42. In each corner a particularly shaped receiving opening 43 is formed into which fasteners, for example, self-cutting screws or expanding clamps, can be inserted at the end-side. An opening defined by two mutually parallel fixed links 44 is provided on the side opposite the connecting link 42.

The extruded light metal hollow profiles illustrated in FIGS. 3 to 5 may also be used in this design or in similar designs for other types of lifting platforms, such as are illustrated e.g. in FIGS. 8 and 9. In the two-plunger lifting platform according to FIG. 8 and also in the pantograph lifting platform according to FIG. 9, the travel rails 50, 51 or 52, 53 may be extruded light metal hollow profiles in one of the embodiments illustrated in FIGS. 3 to 5. Each hollow profile may comprise an inside angular guide 54, as is also shown in FIGS. 3 to 5. In these guides, additional units, for example wheel-free jacks, may be positioned and moved in a longitudinal direction. Furthermore, in the two-plunger lifting platform according to FIG. 8, the guide pipes 55 of the two lifting plungers may also be formed as extruded light metal hollow profiles. Correspondingly, the two supporting rails 56 of the pantograph lifting platform according to FIG. 9 and the pantograph struts 57, 58 may also be formed as extruded light metal hollow profiles.

The invention is not limited to the embodiments as shown. For example, the extruded light metal hollow profiles used for the functional elements of various types of lifting platforms may also have other suitable cross-sectional configurations, if particular technical requirements have to be fulfilled. It is essential that the intended creation of a higher value be achieved by using extruded hollow profiles made of aluminium or Al alloys which are prefabricated as far as possible.

1. A lifting device, particularly for motor vehicles, having
a lifting unit and
load-bearing functional elements, such as travel rails, stators, support arms, or the like, which are made of extruded light metal hollow profiles having integrally formed reinforcements, wherein
the hollow profiles forming the travel rails comprise closed longitudinal cavities,
wherein
each hollow profile has two lateral channel-like longitudinal cavities, connected to each other by a plate-shaped fastener, thereby forming a continuous travel surface.

2. The lifting device according to claim 1,
wherein
the travel rails are fastened with their plate-shaped middle part to the upper ends of underground lifting plungers and their guide pipes, respectively.

3. The lifting device according to claim 1,
wherein
the travel rails are attached with their ends to transverse beams which are guided at the end-side on columns by a motor in a vertically movable fashion.

4. The lifting device according to claim 3,
wherein
the transverse beams can be vertically moved on the columns by means of traction cords coupled to the piston rod head of a pressurizing medium cylinder via pulleys.

5. The lifting device according to claim 4,
wherein
the pressurizing medium cylinder with the piston rod head and pulleys supported thereon is arranged axially parallel inside a hollow profile.

6. The lifting device according to claim 1,
wherein
the drive unit for the lifting and lowering movements of the running rails consisting of light metal hollow profiles is a pantograph structure the load-bearing struts of which are light metal hollow profiles.
